(19) United States
(12) Patent Application Publication
(10) Pub. No.: US 2022/0321491 A1
(43) Pub. Date: Oct. 6, 2022

(54) MICROSERVICE DATA PATH AND CONTROL PATH PROCESSING

(71) Applicant: Intel Corporation, Santa Clara, CA (US)

(72) Inventors: Susanne M. BALLE, Hudson, NH (US); Shihwei CHIEN, Zhubei (TW); Duane E. GALBI, Wayland, MA (US); Nagabhushan CHITLUR, Portland, OR (US)

(21) Appl. No.: 17/844,506

(22) Filed: Jun. 20, 2022

(51) Int. Cl. H04L 47/43; H04L 67/133

(52) U.S. Cl. CPC H04L 47/43; H04L 67/133

(57) ABSTRACT

Examples described herein relate to a network interface device that includes circuitry to process data and circuitry to split a received flow of a mixture of control and data content and provide the control content to a control plane processor and provide the data content for access to the circuitry to process data, wherein the mixture of control and data content are received as part of a Remote Procedure Call. In some examples, provide the control content to a control plane processor, the circuitry is to remove data content from a received packet and include an indicator of a location of removed data content in the received packet.

### BACKGROUND

Data centers are shifting from deploying monolithic applications to applications composed of communicatively coupled microservices. Data centers are offloading workloads, from execution by general purpose central processing units (CPUs), to execution on XPU platforms with specialized Data Processing Units (DPUs) and/or specialized Infrastructure Processing Units (IPUs) such as Amazon Web Services (AWS) Aqua, Nvidia Bluefield, Google VCU, Microsoft FPGA IPU, Fungible, etc.

### BRIEF DESCRIPTION OF THE DRAWINGS

FIG. 1 depicts an example of microservices deployment.

FIG. 2 depicts an example platform.

FIG. 3 depicts an example system.

FIG. 4A depicts an example of operations for packet receipt.

FIG. 4B depicts an example of operations for packet transmission.

FIG. 5 shows an illustration of modification of packets.

FIG. 6 depicts an example HTTP/2 processor.

FIG. 7 depicts an example Protobuf (PB) filter circuitry.

FIGS. 8A and 8B depict example processes to process respective received packets with and packets

FIG. 9 depicts an example network interface device.

FIG. 10 depicts an example system.

FIG. 11 depicts an example system.

### DETAILED DESCRIPTION

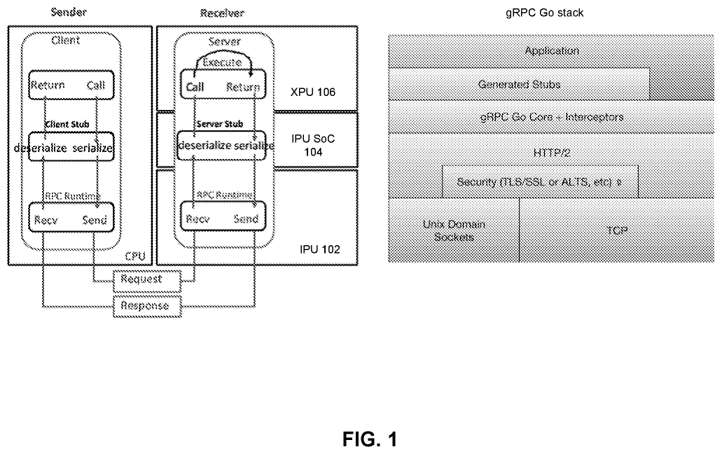

FIG. 1 depicts an example of microservices deployment on an IPU based on mapping of a Google Remote Procedure Call (gRPC) stack. For example, gRPC communication can be sent using Transmission Control Protocol (TCP) or Unix domain sockets (e.g., User Datagram Protocol (UDP)). IPU 102 can include an system on chip (SoC) 104 that can execute a cloud native gRPC Go stack as a target for microservices. gRPC communications include separate control and data traffic (protobuf). IPU SoC 104 can include at least two interfaces to IPU SoC 104 and XPU 106. IPU SoC 104 can copy data to XPU 106 for processing. Latency can arise from IPU SoC 104 copying data to XPU 106. While examples are described with respect to gRPC, other protocols can be used such as JSON, XML, Open Network Compute(ONC) RPC, and others.

At least for microservice-to-microservice communications, a microservice software stack such as a service mesh and operating system (OS) networking stack (e.g., Linux TCP/IP stack) can be offloaded from a general purpose processor for execution by a network interface device. The network interface device can receive control and data traffic. For example, the network interface device, such as a DPU or IPU, can provide control and data traffic to a general purpose processor (e.g., CPU) or processors in a system on chip (SoC) that executes a microservice server. However, latency of data processing can arise if the control and data are to be processed by different processors. Where the data traffic is to be processed by an accelerator or other processor (e.g., XPU), the general purpose processor can provide data traffic to the accelerator (e.g., field programmable gate array (FPGA) executing one or more kernels) or other processor.

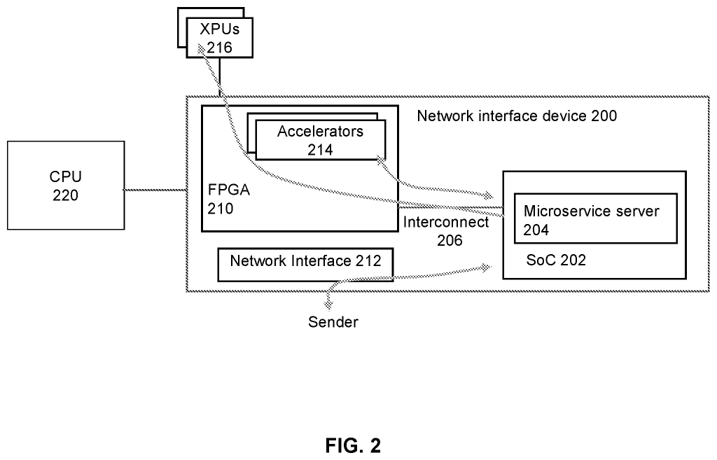

FIG. 2 depicts an example platform. Network interface device 200 can include SoC 202 coupled by interconnect 206 to FPGA 210. For example, SoC 202 can include one or more microprocessors and one or more memory devices. SoC 202 can execute microservice server stack 204. Microservice server stack 204 can include a service mesh and protocol processing stack. A service mesh can include an infrastructure layer for facilitating service-to-service communications between microservices using application programming interfaces (APIs). A service mesh can be implemented using a proxy instance (e.g., sidecar) to manage service-to-service communications. Some network protocols used by microservice communications include Layer 7 protocols, such as Hypertext Transfer Protocol (HTTP), HTTP/2, remote procedure call (RPC), gRPC, Kafka, MongoDB wire protocol, and so forth. Envoy Proxy is a well-known data plane for a service mesh. Istio, AppMesh, and Open Service Mesh (OSM) are examples of control planes for a service mesh data plane. Microservice server 204 can include one or more of: network interface driver, operating system (OS), networking stack, HTTP/2 server software, micro-service application (e.g., microservices, virtual machines (VMs), containers, or other distributed or virtualized execution environments).

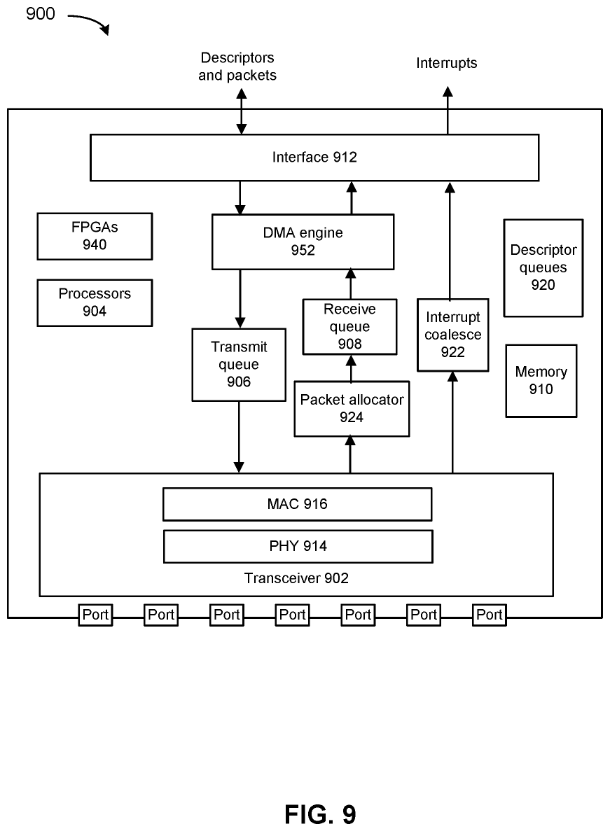

FPGA 210 can perform compute and inline processing of packets. Network interface 212 can receive packets from sender directed to microservice server 204. Various examples of network interface device 200 are described with respect to FIG. 9.

Interconnect 206 between SoC 202 and FPGA 210 could be operate in a manner consistent with Peripheral Component Interconnect Express (PCIe), Compute Express Link (CXL), or others. Interconnect 206 can be implemented as an optical interface, electrical interface, network on chip (NoC), or so on. FPGA 210 can include or access accelerators 214 or one or more XPUs. Network traffic from IPU network interface go to the microservice software stack running on SoC/CPU inside the IPU, and SoC dispatches required data to and collects result from accelerators on AFUs or XPUs.

Microservice server stack 204 can process control packets and information from sender and provide data from sender to FPGA 210 for processing by accelerators 214, XPUs 216, or CPU 220. Mixing of control and data flows can lead to an extra hop or copy operation prior to processing of the data by accelerator 214, XPU 216, or CPU 220. For example, XPU 216 can include one or more of: GPU, FPGA, digital signal processor (DSP), application specific integrated circuit (ASIC), and others. Latency of data processing can arise from microservice server stack 204 providing data to FPGA 210 for processing or routing. Accordingly, network interface device 200 providing an interface to a microservice server can introduce a bottleneck or latency.

At least to reduce latency or time to complete processing of data, the network interface device can include circuitry (e.g., system on chip (SoC)) or FPGA) that can detect control traffic and data traffic and direct control traffic to a microservice server and data traffic to an accelerator or other processor for processing. A microservice server can include a processor-executed OS networking stack (e.g., Internet Control Message Protocol (ICMP) traffic, microservice discovery and configuration request). For example, the OS networking stack may not provide a determination if traffic is data traffic and is to be provided to an accelerator to avoid a data copy operation and avoid context switch. Accordingly, CSPs can deploy workloads in disaggregated datacenters and potentially utilize less power while delivering better performance per watt, while attempting to meet or exceed key performance indicators (KPIs) around performance per watt, algorithm design, etc.

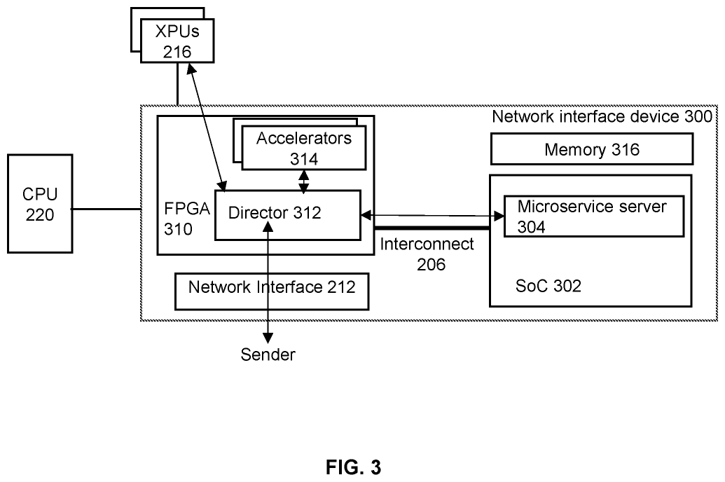

FIG. 3 depicts an example system. Instead of transferring network traffic from sender to microservice software stack 304 executing on SoC 302, FPGA 310 can include access director 312 to separate configuration and data path at a network packet level. Director 312 can process gRPC/HTTP2 messages and dispatch data (e.g., data primitives) to hardware accelerators 314 and/or XPUs 216 by storage into memory 316 or memory internal to XPUs 216 or accelerators 314. Director 312 can dispatch control and configuration traffic (e.g., control primitives) by storage into memory 316 for microservice server 304 to perform gRPC control layers to maintain HTTP/2 (e.g., RFC 7540 (2015)) and TCP connections. Director 312 can merge results generated by accelerators 314 and/or XPUs 216 can be merged with data generated by SoC 302 into a gRPC response message for transmission. A gRPC response message can include one or more of: HTTP/2 header, gRPC response for control and data result in HTTP/2 response body such as data processed by accelerators 314 and/or XPUs 216. Data processing latency by kernel tasks executed by hardware accelerators 314 and XPUs 216 can be reduced. Director 312 can be implemented as one or more application specific integrated circuits (ASICs); one or more field programmable gate arrays (FPGAs); or other circuitry. In some examples, director 312 can be formed as part of FPGA 310.

XPUs 216 can be shared across multiple microservices. Configuration of accelerators 314 (e.g., FPGAs) can be based on load, workload type, and multiplexing microservices servers 304.

Configuration of FPGA 310 and director 312 can be performed by an application or other software based on Storage Performance Development Kit (SPDK), Data Plane Development Kit (DPDK), OpenDataPlane (ODP), Infrastructure Programmer Development Kit (IPDK), or others.

Latency of data processing and higher throughput can be achieved for incoming data and outgoing results at least by reducing a number of interface traversals between FPGA 310 to SoC 302 and SoC 302 to XPUs 216 or accelerators 314. Data traversals to XPUs 216 or accelerators 314 may not be directed by SoC 302 software stack, whose speed may be bounded by processing capability of SoC 302.

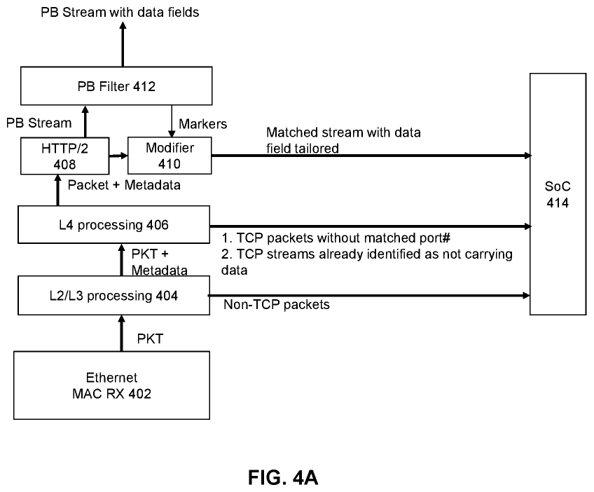

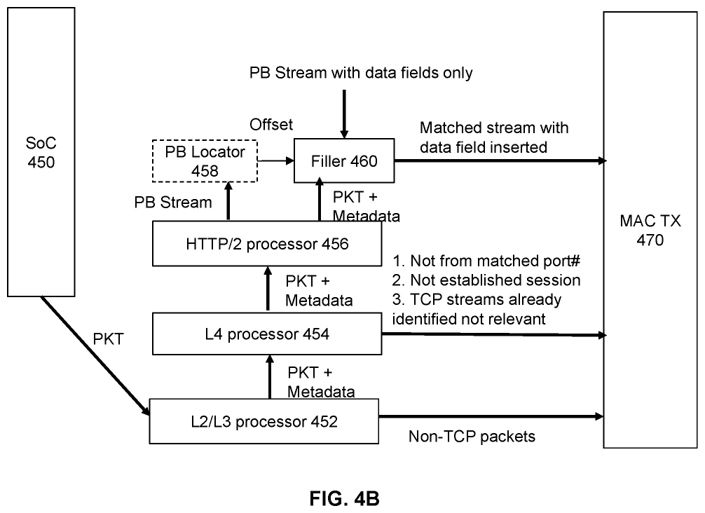

FIG. 4A depicts an example of operations for packet receipt. For example, the system of FIG. 4A can be used in network interface device 300. Ethernet MAC receive (RX) interfaces 402 can perform MAC layer processing of received packets, potentially including a gRPC request, as described herein. For incoming packets from Ethernet MAC RX 402, data link and network layer (e.g., L2/L3) processing 404 can detect and direct non-TCP packets to SoC 414 for processing. In some examples, UDP packets may not carry data whereas TCP packets can carry data.

Transport layer (e.g., L4) processing circuitry 406 can perform TCP connection lookup and reassembly for TCP packets received out-of-order. L4 processing circuitry 406 can provide TCP packets that do not match a configuration of ingress port number that corresponds to data traffic and/or TCP packets of TCP streams identified as not carrying data to SoC 414 for processing. L4 processing circuitry 406 can provide TCP packets that match a configured data packet ingress port and state and state (e.g., Port 80/433 or configured TCP port number with established TCP connection after TCP 3-way handshaking) to HTTP/2 processor 408 for further processing.

HTTP/2 processor 408 can perform HTTP/2 header and data frame parsing and perform a comparison on whether this HTTP/2 stream matches the configuration defined by microservice server (e.g. specified URL and content-type fields in HTTP/2 request header) associated with received data. HTTP/2 processor 408 can provide a data frame to protocol buffer (protobuf (PB)) filter 412 to extract exactly the data fields for processing by an accelerator or XPU. If a packet contains such data fields, the corresponding payload can be removed from the packet by modifier 410 prior to being provided to SoC 414. Post-processing such as checksum re-calculation can be performed by modifier 410 for packets that were modified to have payload removed (e.g., payload turned to zero values or truncated to remove portions that are data) and provide the modified packets to SoC 414.

In some examples, FPGA 310 can include one or more of: Ethernet MAC interfaces 402, data link and network layer processing 404, transport layer processing 406, HTTP/2 processing 408, modifier 410, and/or PB filter 412.

FIG. 4B depicts an example of operations for packet transmission. For outgoing packets from SoC 450, data link and network layer (e.g., L2/L3) processing circuitry 452 can provide non-TCP packets (PKTs) to MAC transmitter 470. For packets not filtered by data link and network layer processor 452, transport layer (e.g., L4) processing circuitry 454 can perform filtering to provide packets directed to an egress port number that corresponds to data traffic and/or TCP packets of TCP streams identified as not carrying data to MAC transmitter 470 for MAC layer processing and subsequent transmission. For packets not filtered by transport layer processing circuitry 454, HTTP/2 processor 456 can determine if a gRPC response stream was located, based on presence of a gRPC response stream, cause PB locator circuitry 458 to locate a payload position where the response protobuf stream resides, calculate an offset, and provide such offset to filler circuitry 460. Filler circuitry 460 can combine protobuf data (e.g., PB stream with data fields only) generated by an accelerator or XPU into a payload and perform post-processing operations such as checksum re-calculation for the generated packet and provide the generated packet to MAC transmitter 470 for MAC layer processing and subsequent transmission.

In some examples, FPGA 310 can include one or more of: data link and network layer (e.g., L2/L3) processing circuitry 452, transport layer (e.g., L4) processing circuitry 454, HTTP/2 processor 456, PB locator circuitry 458, filler circuitry 460, and/or MAC transmitter 470.

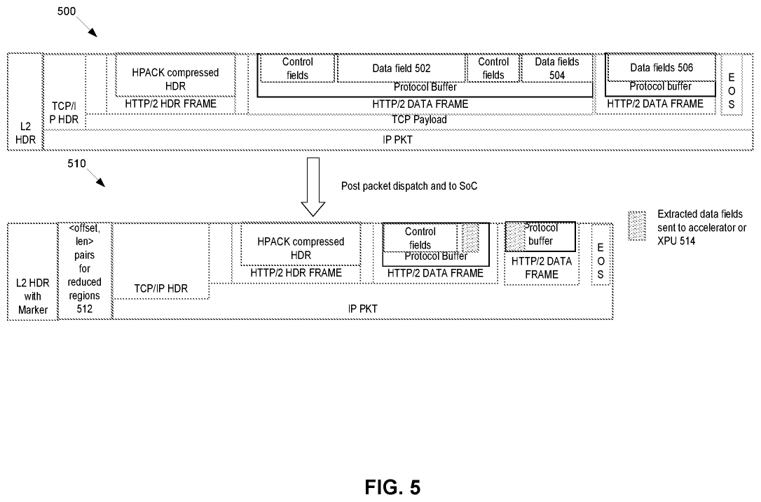

FIG. 5 shows an illustration of modification of packets. For example, for a matched HTTP/2 stream, the packet includes an HTTP/2 header (HDR) frame with HPACK compressed header data (e.g., RFC 7541 (2015)). The packet can include multiple HTTP/2 data frames that compose a ProtocolBuffer for gRPC request data. The packet can include control fields and data fields. After network sub-system processing by a director, described herein, the data in data fields 502, 504, and 506 can be extracted and delivered to an accelerator or XPU. The director can modify the original packet by removing data fields and reducing a size of the packet or replacing data in the data fields with zeros. The direct can provide an <offset, length (len)> 512 to indicate one or more portions of the packet with data that were removed.

For example, in packet 500, data 502 starts at packet position offset byte 100 and has a length of 20 bytes and <offset, len> can be set to 100, 20. Other <offset, len> can be specified for data 504 and data 506. A microservice service stack to skip over data of length <offset, len> or <offset, len> can be used to reconstruct a packet with data to its original size. Reducing a size of packet can reduce interface bandwidth utilized to send a packet to an SoC or its memory.

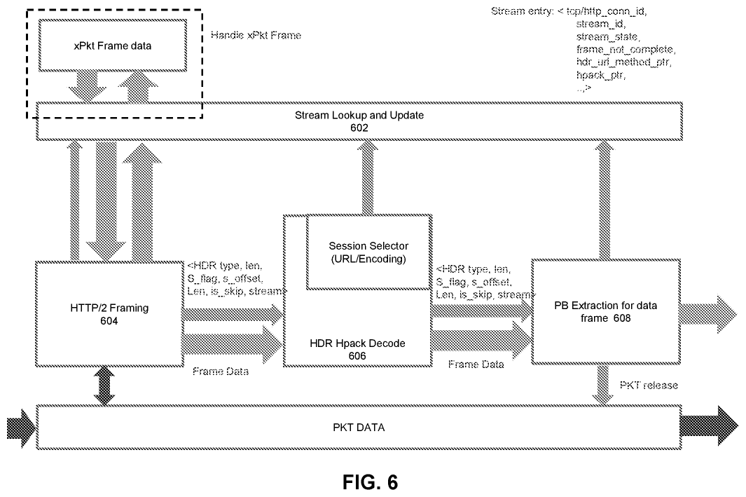

FIG. 6 depicts an example HTTP/2 processor. A TCP protocol processing stack (e.g., executed by L4 processor 454) can associate L4 meta data with a packet stream and the packet content can be stored in PKT DATA in FPGA internal memory (e.g., static random access memory (SRAM) or external Double Data Rate (DDR) memory). Stream lookup and update 602 can place stream information into a table. Stream information can include one or more of: TCP/http_connection_id, stream_id, stream_state, is_frame_complete, URL_method_pointer, HPACK_pointer and others.

An HTTP/2 frame can span across multiple packets. HTTP/2 framing circuitry 604 is to identify and to locate the position of HTTP/2 frames within packets. HTTP/2 framing circuitry 604 can process an TCP/HTTP connection to determine if a last HTTP/2 frame is not complete. based on current header length+remaining bytes. When an HTTP/2 frame is identified as spanning across multiple packets, partial data in previous packet(s) can be retrieved to construct an HTTP/2 frame.

For an HTTP/2 header frame, HDR Hpack decode circuitry 606 can attempt to decode the compressed HTTP/2 header into separate fields and their corresponding values. HDR Hpack decode circuitry 606 can perform a comparison in Session Selector to determine if this HTTP request session is a target by checking the configured policies (e.g., content type and encoding is “protobuf” AND Uniform Resource Locator (URL) is matched. HDR Hpack decode circuitry 606 can update tag based on stream information from Session Selector. If a stream is not an gRPC target, it can be skipped, and provided to a microservice server. If a stream includes gRPC data frames, PB extraction circuitry 608 can provide data to ProtocolBuf (PB) filter, described herein.

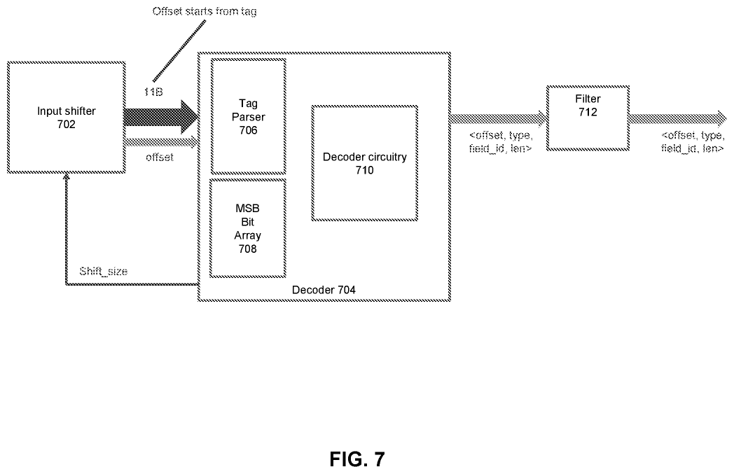

FIG. 7 depicts an example Protobuf (PB) filter circuitry. According to gRPC Protobuf definition, a field of a data structure can be encoded into a wire-type format, with associated field_id and wire_type for the field. A field may have varied length. Filtering can be performed sequentially as the length of fields is not a fixed value. Input shifter 702 is to adjust the input data to the start of a field and provide 11 bytes, which can be the longest possible length for a VARINT wire type. Decoder 704 can include tag parser 706 to check the tag (e.g., identifier and type) and determine offset for a next field if the field type has a fixed length. For VARINT, the length can be set by an MSB bit of following bytes. MSB bit array parser 708 can identify the nearest bytes with MSB bit value to determine a length of VARINT type field. Decoder 704 can output <offset, type, field_id, and length>. Field length can be provided to input shifter 702 to move input data to a start of a next field. Filter circuitry 712 can distinguish data and control fields based on field_id and can be pre-configured or runtime-configured. Filter circuitry 712 can output information for data fields to be transmitted to accelerators or XPUs. Modifier circuitry, described earlier, can utilize such information to carve out those data fields from the original packet payload, perform changes on packet header (e.g., revise length and checksum values) to provide a packet to the SoC and include merely configuration fields and no data fields.

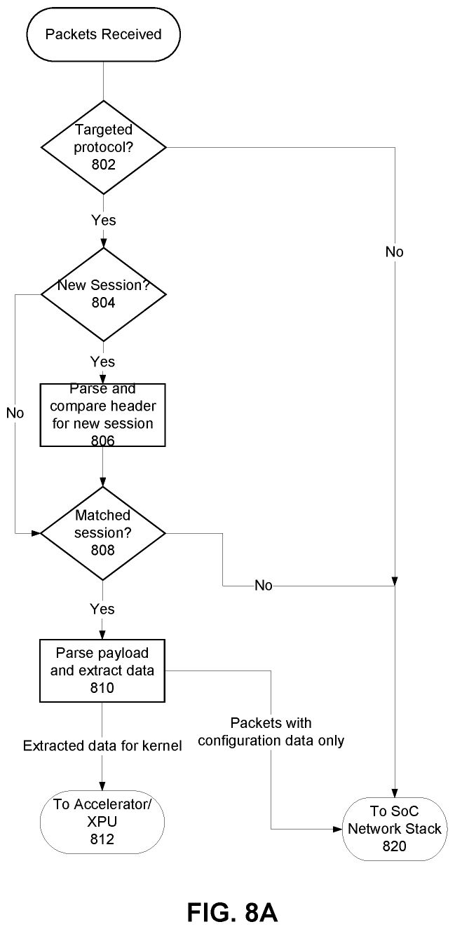

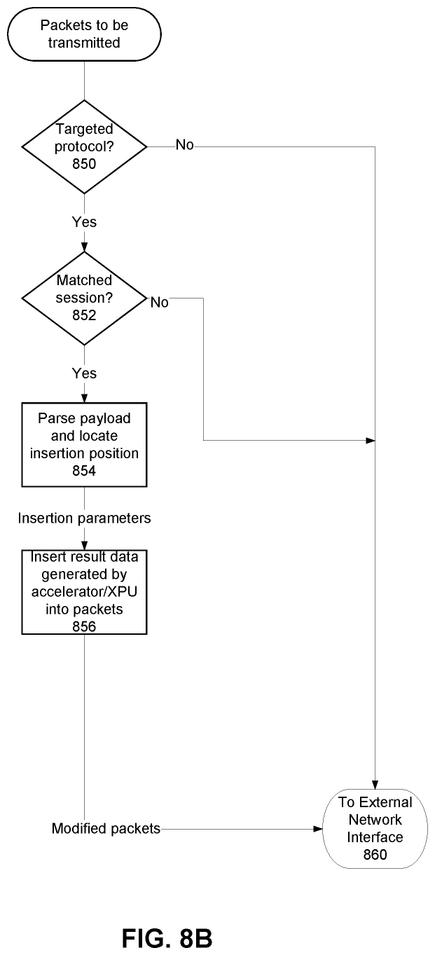

FIGS. 8A and 8B depict example processes to process respective received packets with and packets prior to transmission. Received packets can include gRPC requests whereas packets to be transmitted can include gRPC responses. As shown in FIG. 8A, packet traffic can be received at a network interface. A gRPC connection and corresponding connection ID can refer to a stream that conveys control and data. At 802, the received packet can be processed to determine if the received packet utilizes a targeted protocol for gRPC communications or HTTP2 stack. Other protocols can be utilized, for example, TCP packet with a particular destination port (e.g., port 80). If the received packet utilizes a targeted protocol, the process can proceed to 804. If the received packet does not utilize a targeted protocol, the received packet can be provided to an SoC or CPU directly for processing by a microservice server at 820. At 804, the received packet can be parsed at HTTP/2 layer to determine if the received packet is associated with a new session. If a new session has been established, the process can continue to 806. If a new session has been not established and the received packet corresponds to an existing session, the process can continue to 808. At 806, the HTTP/2 header can be parsed and compared to determine if header values meet a configuration, such as a URL path and content encoding type. For a matched session, the process can continue to 810. For non-matched session, the process can continue to 820, where the received packet can be provided to an SoC or CPU directly for processing by a microservice server.

At 810, the HTTP/2 data can be parsed. Data to be processed by an accelerator or XPU are forwarded to an accelerator or XPU for processing at 812. The configuration data in HTTP/2 data portion can be preserved. The packets with control information and configuration data, modified to remove data, can be provided to an SoC or CPU directly for processing by a microservice server at 820.

FIG. 8B depicts a process for managing packets prior to transmission. The process can be performed by a microservice server software stack and network interface device's processor or FPGA. The packets can include gRPC responses. After an accelerator or XPU finishes data processing and generates a result, accelerator or XPU can notify the microservice software stack running on SoC or CPU.

At 850, a determination can be made if the packet utilizes a target protocol for gRPC communications or HTTP2 stack. Other protocols can be utilized, for example, TCP packet with a particular destination port (e.g., port 80). If the packet utilizes a targeted protocol, the process can proceed to 852. If the packet does not utilize a targeted protocol, the packet can be provided for transmission at 860. At 852, a determination can be made if the packet is associated with an existing session for gRPC communications. If the packet is associated with an existing session for gRPC communications, the process can proceed to 854. If the packet is not associated with an existing session for gRPC communications, the process can proceed to 860 to transmit the packet.

In some examples, the microservice server software stack can generate responses with configuration data and the FPGA or other processor in the network interface device can parse the outgoing traffic and find the expected location to insert the data result to form a complete response message. At 854, the payload of the packet can be parsed to determine insertion positions for data from the accelerator or XPU. At 856, the data from the accelerator or XPU can be inserted into the packet based on position metadata. A complete response message can be provided to the network interface device to transmit the packet to a destination (e.g., gRPC requester) at 860.

FIG. 9 depicts an example network interface device. In some examples, processors 904 and/or FPGAs 940 can be configured to perform routing of data to an accelerator or XPU and routing of control signals to an SoC as well as removal of data from a packet or insertion of data into a packet, as described herein. Some examples of network interface 900 are part of an Infrastructure Processing Unit (IPU) or data processing unit (DPU) or utilized by an IPU or DPU. An XPU or xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 900 can include transceiver 902, processors 904, transmit queue 906, receive queue 908, memory 910, and bus interface 912, and DMA engine 952. Transceiver 902 can be capable of receiving and transmitting packets in conformance with the applicable protocols such as Ethernet as described in IEEE 802.3, although other protocols may be used. Transceiver 902 can receive and transmit packets from and to a network via a network medium (not depicted). Transceiver 902 can include PHY circuitry 914 and media access control (MAC) circuitry 916. PHY circuitry 914 can include encoding and decoding circuitry (not shown) to encode and decode data packets according to applicable physical layer specifications or standards. MAC circuitry 916 can be configured to perform MAC address filtering on received packets, process MAC headers of received packets by verifying data integrity, remove preambles and padding, and provide packet content for processing by higher layers. MAC circuitry 916 can be configured to assemble data to be transmitted into packets, that include destination and source addresses along with network control information and error detection hash values.

Processors 904 can be one or more of: combination of: a processor, core, graphics processing unit (GPU), field programmable gate array (FPGA), application specific integrated circuit (ASIC), or other programmable hardware device that allow programming of network interface 900. For example, a “smart network interface” or SmartNIC can provide packet processing capabilities in the network interface using processors 904.

Processors 904 can include a programmable processing pipeline that is programmable by Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86 compatible executable binaries or other executable binaries. A programmable processing pipeline can include one or more match-action units (MAUs) that can schedule packets for transmission using one or multiple granularity lists, as described herein. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 904 and/or FPGAs 940 can be configured to perform event detection and action.

Packet allocator 924 can provide distribution of received packets for processing by multiple CPUs or cores using receive side scaling (RSS). When packet allocator 924 uses RSS, packet allocator 924 can calculate a hash or make another determination based on contents of a received packet to determine which CPU or core is to process a packet.

Interrupt coalesce 922 can perform interrupt moderation whereby network interface interrupt coalesce 922 waits for multiple packets to arrive, or for a time-out to expire, before generating an interrupt to host system to process received packet(s). Receive Segment Coalescing (RSC) can be performed by network interface 900 whereby portions of incoming packets are combined into segments of a packet. Network interface 900 provides this coalesced packet to an application.

Direct memory access (DMA) engine 952 can copy a packet header, packet payload, and/or descriptor directly from host memory to the network interface or vice versa, instead of copying the packet to an intermediate buffer at the host and then using another copy operation from the intermediate buffer to the destination buffer.

Memory 910 can be any type of volatile or non-volatile memory device and can store any queue or instructions used to program network interface 900. Transmit traffic manager can schedule transmission of packets from transmit queue 906. Transmit queue 906 can include data or references to data for transmission by network interface. Receive queue 908 can include data or references to data that was received by network interface from a network. Descriptor queues 920 can include descriptors that reference data or packets in transmit queue 906 or receive queue 908. Bus interface 912 can provide an interface with host device (not depicted). For example, bus interface 912 can be compatible with or based at least in part on PCI, PCIe, PCI-x, Serial ATA, and/or USB (although other interconnection standards may be used), or proprietary variations thereof.

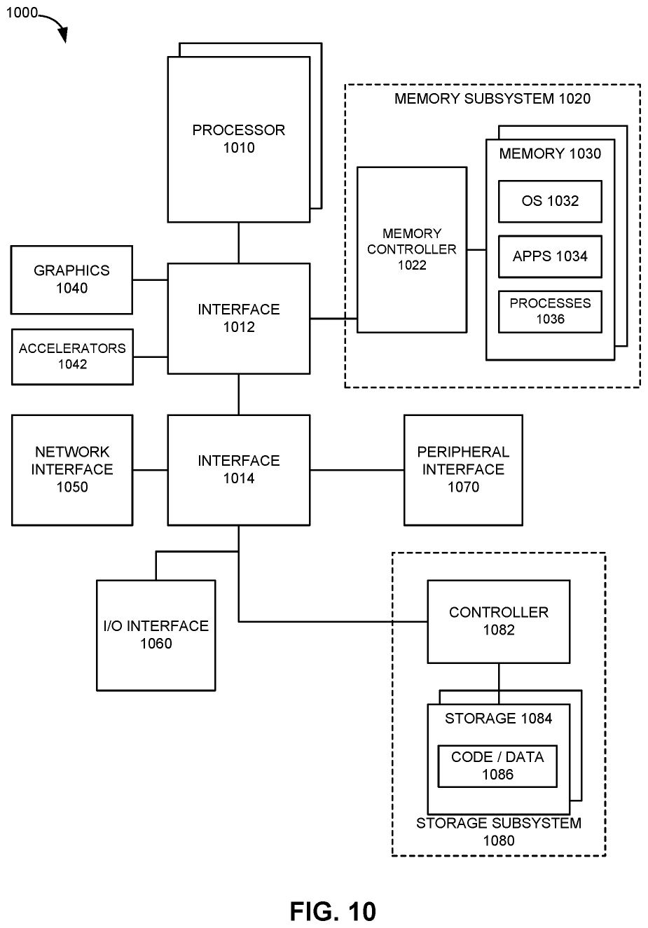

FIG. 10 depicts an example system. Components of system 1000 (e.g., processor 1010, accelerators 1042, network interface 1050, and so forth) can be configured to perform routing of data to an accelerator or XPU and routing of control signals to an SoC as well as removal of data from a packet or insertion of data into a packet, as described herein, as described herein. System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Where present, graphics interface 1040 interfaces to graphics components for providing a visual display to a user of system 1000. In one example, graphics interface 1040 can drive a high definition (HD) display that provides an output to a user. High definition can refer to a display having a pixel density of approximately 100 PPI (pixels per inch) or greater and can include formats such as full HD (e.g., 1080 p), retina displays, 4K (ultra-high definition or UHD), or others. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a fixed function or programmable offload engine that can be accessed or used by a processor 1010. For example, an accelerator among accelerators 1042 can provide compression (DC) capability, cryptography services such as public key encryption (PKE), cipher, hash/authentication capabilities, decryption, or other capabilities or services. In some embodiments, in addition or alternatively, an accelerator among accelerators 1042 provides field select controller capabilities as described herein. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

OS 1032 and/or a driver for network interface 1050 can configure network interface 1050 to perform routing of data to an accelerator or XPU and routing of control signals to an SoC as well as removal of data from a packet or insertion of data into a packet, as described herein, as described herein.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory.

Network interface 1050 can include one or more of: a network interface controller (NIC), a remote direct memory access (RDMA)-enabled NIC, SmartNIC, router, switch, or network-attached appliance. Some examples of network interface 1050 are part of an Infrastructure Processing Unit (IPU) or data processing unit (DPU) or utilized by an IPU or DPU. An XPU or xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. A programmable pipeline can be programmed using one or more of: P4, SONiC, C, Python, Broadcom Network Programming Language (NPL), NVIDIA® CUDA®, NVIDIA® DOCA™, Infrastructure Programmer Development Kit (IPDK), or x86 compatible executable binaries or other executable binaries.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. Dynamic volatile memory uses refreshing the data stored in the device to maintain state. One example of dynamic volatile memory includes DRAM (Dynamic Random Access Memory), or some variant such as Synchronous DRAM (SDRAM). An example of a volatile memory include a cache. A memory subsystem as described herein may be compatible with a number of memory technologies, such as those consistent with specifications from JEDEC (Joint Electronic Device Engineering Council) or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), a combination of one or more of the above, or other memory.

A power source (not depicted) provides power to the components of system 1000. More specifically, power source typically interfaces to one or multiple power supplies in system 1000 to provide power to the components of system 1000. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1000 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., Non-Volatile Memory Express (NVMe) Specification, revision 1.3c, published on May 24, 2018 or earlier or later versions, or revisions thereof).

Communications between devices can take place using a network that provides die-to-die communications; chip-to-chip communications; circuit board-to-circuit board communications; and/or package-to-package communications.

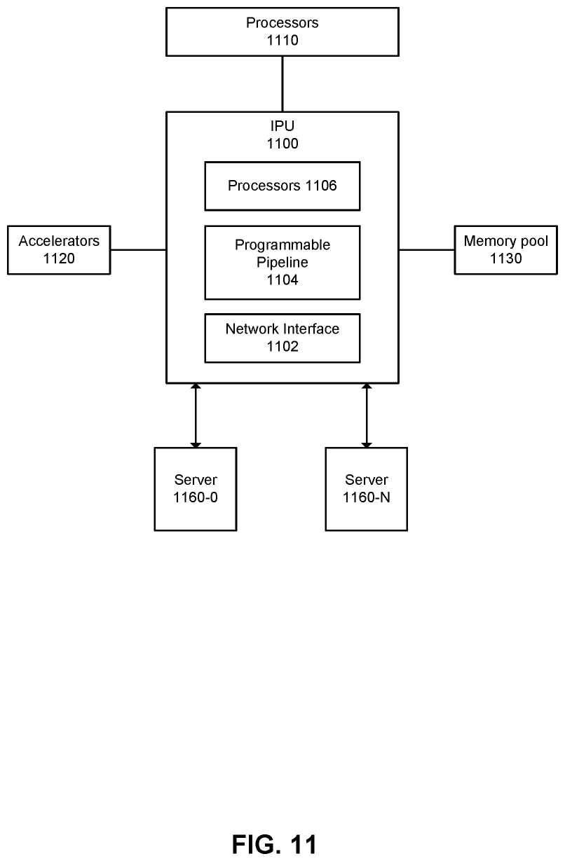

FIG. 11 depicts an example system. In this system, IPU 1100 manages performance of one or more processes using one or more of processors 1106, processors 1110, accelerators 1120, memory pool 1130, or servers 1140-0 to 1140-N, where N is an integer of 1 or more. In some examples, processors 1106 of IPU 1100 can execute one or more processes, applications, VMs, containers, microservices, and so forth that request performance of workloads by one or more of: processors 1110, accelerators 1120, memory pool 1130, and/or servers 1140-0 to 1140-N. IPU 1100 can utilize network interface 1102 or one or more device interfaces to communicate with processors 1110, accelerators 1120, memory pool 1130, and/or servers 1140-0 to 1140-N. IPU 1100 can utilize programmable pipeline 1104 to process packets that are to be transmitted from network interface 1102 or packets received from network interface 1102. Programmable pipeline 1104 and/or processors 1106 can be configured to perform routing of data to an accelerator or XPU and routing of control signals to a SoC as well as removal of data from a packet or insertion of data into a packet, as described herein.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: a device interface and a network interface device, coupled to the device interface, comprising: circuitry to process data and circuitry to split a received flow of a mixture of control and data content and provide the control content to a control plane processor and provide the data content for access to the circuitry to process data, wherein the mixture of control and data content are received as part of a Remote Procedure Call.

Example 2 includes one or more examples, wherein to provide the control content to a control plane processor, the circuitry is to remove data content from a received packet and include an indicator of a location of removed data content in the received packet.

Example 3 includes one or more examples, wherein the control content comprises one or more of: User Datagram Protocol (UDP) packets, Transmission Control Protocol (TCP) packets with destination port number corresponding to non-data content, or TCP streams identified as not including data content.

Example 4 includes one or more examples, wherein the control plane processor is to execute a microservice server to process the control content.

Example 5 includes one or more examples, wherein the network interface device comprises: circuitry to insert data into a packet with control content, wherein the packet comprises at least one indicator of one or more positions to insert the data into the packet prior to transmission of the packet.

Example 6 includes one or more examples, wherein the circuitry is to insert data into the packet with control content based on indicators of a data position in the packet.

Example 7 includes one or more examples, wherein the received control and data flows are consistent with Google Remote Procedure Call (gRPC).

Example 8 includes one or more examples, wherein the circuitry to process data comprises one or more application specific integrated circuits (ASICs); one or more field programmable gate arrays (FPGAs).

Example 9 includes one or more examples, wherein the network interface device comprises one or more of: a network interface controller (NIC), a remote direct memory access (RDMA)-enabled NIC, SmartNIC, router, or a switch.

Example 10 includes one or more examples, and includes a non-transitory computer-readable medium comprising instructions stored thereon, that if executed by one or more processors, cause the one or more processors to: configure a network interface device to detect control content and data content in at least one packet received as part of a Remote Procedure Call and direct control content to a first processor that is to execute a control plane and data content to a second processor, wherein the first processor is in the network interface device.

Example 11 includes one or more examples, and includes instructions stored thereon, that if executed by one or more processors, cause the one or more processors to: configure the network interface device to remove data content from a received packet of the at least one packet and include an indicator of location of removed data content in the received packet.

Example 12 includes one or more examples, wherein the control content is associated with one or more of: User Datagram Protocol (UDP) packets, Transmission Control Protocol (TCP) packets with destination port number corresponding to non-data content, or TCP streams identified as not including data content.

Example 13 includes one or more examples, wherein the first processor is to execute a microservice server to process the control content.

Example 14 includes one or more examples, and includes instructions stored thereon, that if executed by one or more processors, cause the one or more processors to: configure the network interface device to insert data into a packet with control content, wherein the packet comprises at least one indicator of one or more positions to insert the data into the packet.

Example 15 includes one or more examples, wherein the control content and data content are provided in the at least one packet in a manner consistent with Google Remote Procedure Call (gRPC).

Example 16 includes one or more examples, wherein the second processor comprises an accelerator.

Example 17 includes one or more examples, and includes a method comprising: at a network interface device, detecting a control content and data content of at least one packet received as part of a Remote Procedure Call and direct control content to a first processor and data content to a second processor.

Example 18 includes one or more examples, and includes the network interface device removing data content from a received packet of the at least one packet and including an indicator of location of removed data content in the received packet.

Example 19 includes one or more examples, wherein the control content is associated with one or more of: User Datagram Protocol (UDP) packets, Transmission Control Protocol (TCP) packets with destination port number corresponding to non-data content, or TCP streams identified as not including data content.

Example 20 includes one or more examples, wherein the control content and data content are provided in the at least one packet in a manner consistent with Google Remote Procedure Call (gRPC).

What is claimed is:

1. An apparatus comprising:
a device interface and
a network interface device, coupled to the device interface, comprising:
circuitry to process data and
circuitry to split a received flow of a mixture of control and data content and provide the control content to a control plane processor and provide the data content for access to the circuitry to process data, wherein the mixture of control and data content are received as part of a Remote Procedure Call.

2. The apparatus of claim 1, wherein to provide the control content to a control plane processor, the circuitry is to remove data content from a received packet and include an indicator of a location of removed data content in the received packet.

3. The apparatus of claim 1, wherein the control content comprises one or more of: User Datagram Protocol (UDP) packets, Transmission Control Protocol (TCP) packets with destination port number corresponding to non-data content, or TCP streams identified as not including data content.

4. The apparatus of claim 1, wherein the control plane processor is to execute a microservice server to process the control content.

5. The apparatus of claim 1, wherein the network interface device comprises:
circuitry to insert data into a packet with control content, wherein the packet comprises at least one indicator of one or more positions to insert the data into the packet prior to transmission of the packet.

6. The apparatus of claim 5, wherein the circuitry is to insert data into the packet with control content based on indicators of a data position in the packet.

7. The apparatus of claim 1, wherein the received control and data flows are consistent with Google Remote Procedure Call (gRPC).

8. The apparatus of claim 1, wherein the circuitry to process data comprises one or more application specific integrated circuits (ASICs); one or more field programmable gate arrays (FPGAs).

9. The apparatus of claim 1, wherein the network interface device comprises one or more of:
a network interface controller (NIC), a remote direct memory access (RDMA)-enabled NIC, SmartNIC, router, or a switch.

10. A non-transitory computer-readable medium comprising instructions stored thereon, that if executed by one or more processors, cause the one or more processors to:
configure a network interface device to detect control content and data content in at least one packet received as part of a Remote Procedure Call and direct control content to a first processor that is to execute a control plane and data content to a second processor, wherein the first processor is in the network interface device.

11. The non-transitory computer-readable medium of claim 10, comprising instructions stored thereon, that if executed by one or more processors, cause the one or more processors to:
configure the network interface device to remove data content from a received packet of the at least one packet and include an indicator of location of removed data content in the received packet.

12. The non-transitory computer-readable medium of claim 10, wherein the control content is associated with one or more of: User Datagram Protocol (UDP) packets, Transmission Control Protocol (TCP) packets with destination port number corresponding to non-data content, or TCP streams identified as not including data content.

13. The non-transitory computer-readable medium of claim 10, wherein the first processor is to execute a microservice server to process the control content.

14. The non-transitory computer-readable medium of claim 10, comprising instructions stored thereon, that if executed by one or more processors, cause the one or more processors to:
configure the network interface device to insert data into a packet with control content, wherein the packet comprises at least one indicator of one or more positions to insert the data into the packet.

15. The non-transitory computer-readable medium of claim 10, wherein the control content and data content are provided in the at least one packet in a manner consistent with Google Remote Procedure Call (gRPC).

16. The non-transitory computer-readable medium of claim 10, wherein the second processor comprises an accelerator.

17. A method comprising:
at a network interface device, detecting a control content and data content of at least one packet received as part of a Remote Procedure Call and direct control content to a first processor and data content to a second processor.

18. The method of claim 17, comprising:
the network interface device removing data content from a received packet of the at least one packet and including an indicator of location of removed data content in the received packet.

19. The method of claim 17, wherein the control content is associated with one or more of: User Datagram Protocol (UDP) packets, Transmission Control Protocol (TCP) packets with destination port number corresponding to non-data content, or TCP streams identified as not including data content.

20. The method of claim 17, wherein the control content and data content are provided in the at least one packet in a manner consistent with Google Remote Procedure Call (gRPC).
